(19) United States
(12) Patent Application Publication
(10) Pub. No.: US 2004/0070601 A1
(43) Pub. Date: Apr. 15, 2004

(54) Interface and system using DOCSIS and HMS for management of network transmission equipment

(76) Inventor: John George Staiger, Manlius, NY (US)

Correspondence Address: John George Staiger, 4860 Westfield Drive, Manlius, NY, 13104, US

(21) Appl. No.: 10/269,720

(22) Filed: Oct. 12, 2002

(51) Int. Cl. G09G 5/00

(52) U.S. Cl. 345/738

(57) ABSTRACT

A system and apparatus for the management of elements (devices) in a broadband communications network which implement features of the DOCSIS and SCTE HMS specifications through an interface consisting of physical, electrical and logical protocol. As part of the system, a communications module (transponder) is used to enable the elements of the network to monitor, control, provision, alarm and communicate. Communication occurs over the broadband network media using DOCSIS protocol. The initiator of network management messages targeted at transponders, and the recipient of response messages from transponders, is a distantly located computer system running a network management software system. The network management system software uses standard SNMP and or HMS protocol for communication of messages to the managed device's transponder. The transponder also uses SNMP and HMS protocol to communicate messages to the network management software system.

### BACKGROUND OF INVENTION

Network Management Systems consist of a suite of functions the network operator uses to quantify and maximize Quality of Service (QOS), minimize time to repair and reduce operating expenses. Network management systems have been historically considered by cable television system (CATV) operators as a luxury or a requirement of the franchise authority. The CATV system (sometimes referred to as an HFC network or Broadband Network) traditionally delivered only entertainment services; today, a CATV system may deliver a complete line of telecommunications services, including voice (telephone), video and broadband data. The customer base has expanded from primarily residential to businesses that have specific Quality of Service (QOS) requirements. Now competing with telephone providers, CATV operators must offer comparable or better service than previously demanded. Without network management, the network operator will be unable to compete for today's communications business.

The CATV operator found it challenging to justify an investment in a Network Management System when the service being delivered was limited to entertainment. If the network failed and subscribers lost television service for an hour, it caused little hardship on the subscriber and insignificant financial impact on the CATV operator. However, when a cable operator offers voice and data services, the loss of such services, even for a few minutes, could have a significant negative impact on the subscriber and, therefore, on the cable operator. As a result of this risk, operators are much more motivated to invest in network management. Moreover, the increased revenue from these new services make the investment in network management sound and financially justifiable.

The invention is a means to provide lower cost products that will make investments less of a challenge to show an acceptable return on investment. This can be realized because it utilizes silicon integrated circuits that are generally applied in HFC Cable Modems and expands their applicability to the network media device management functions. Examples of network media devices are Optical Nodes, Optical Transmitters, Optical Receivers, RF Amplifiers and Power Supplies having batteries and or generator for back up power. The ready availability and volume manufacture of DOCSIS integrated circuits make its application for this purpose very practical and attractive compared to the traditional ways of implementing an HFC management transponder.

The invention also provides a more efficient means of maintenance and operations because it facilitates the implementation of network management by taking advantage of existing equipment and avoids the requirement to purchase specialized equipment needed in CATV headends, hubs and central offices to implement traditional network management functionality. More specifically, existing methods of HFC element management uses a device referred to as a Headend Controller. Specialized Headend Controllers for Element Management Systems are not required by this system. The bridging function of Headend Controllers is replaced buy the utilization of existing Cable Modem System CMTS devices.

### DEFINITIONS

| TERM or | |
|---|---|
| ACRONYM | DESCRIPTION OR DEFINITION |
| CATV | Community Antenna Television or Cable Television |
| CMTS | Cable Modem Termination System - This is a gateway |
| | and data packet routing device used by HFC network |
| | operators to transition between the local area network |
| | (LAN), usually inside of a hub or headend, to the HFC |
| | subscriber access network. The network management |
| | system is connected to the LAN. |
| C²M | Common channel messaging |
| DOCSIS | Data Over Cable Service Interface Specification - A |
| | suite of specifications developed in association with |
| | CableLabs and standardized by the Society of Cable |
| | Telecommunications Engineers for data communication |
| | using HFC technology. |
| Element | A process that monitors key parameters (example: |
| Management | power supply voltage, optical power, etc.), controls and |
| | performs key functions (example: switches between |
| | primary and backup equipment, changes state of ingress |
| | isolation switches, etc.), provisions for the operation |
| | (example: sets alarm limits, sets gain levels, etc.) and |
| | communicates the values of the monitored parameters |
| | and status of elements (devices) in a network to a |
| | remote software system that processes the data for |
| | management purposes. |
| Headend | A device that bridges between a data network and the |
| Controller | HFC network. It contains RF modulators and |
| | demodulators (MODEMs), a computer processor, and |
| | software programs. Sometimes this device is referred to |
| | as an HMTS. |
| HFC | Hybrid Fiber and Coaxial |
| HMTS | Hybrid Management Sublayer Termination System |
| Hybrid Fiber | An architecture and technology commonly used by |
| and Coaxial | cable television and other broadband service providers |
| System | to distribute telecommunications services to residential, |
| | business and institutional customers. |
| HMS | Hybrid Management Sublayer is a suite of specifications |
| | being standardized by the Society of Cable Television |
| | Engineers that defines physical, electrical and logical |
| | protocol for communications between network |
| | management software and the devices it manages. |
| I/O | Input / Output |
| LAN | Local Area Network |
| QOS | Quality of Service |
| RF | Radio Frequency |
| SCTE | Society of Cable Telecommunications Engineers |
| SNMP | Simple Network Management Protocol |
| Status | A subset of the functions of a network management |
| monitoring | system and element management system that remotely |
| | monitors critical performance and status parameters of |
| | the network and reported the information to a |
| | strategically located processor for display, archiving, |
| | alarming and other purposes. |
| WAN | Wide Area Network |

### SUMMARY OF INVENTION

A feature of the invention is the system (FIG. 1) resulting from the adaptation of various hardware and software components which, when implemented in the fashion of this invention, provides a method for the provisioning, monitoring, control, performance of processes, and alarming of devices critical to the operation of a subscriber access network such as networks that use HFC, RF wireless or optical wireless technologies.

A component of the system is a communications device known as a transponder that implements applicable features of the DOCSIS suite of specifications, applicable features of the SCTE HMS specification and the means of interfacing between them.

The transponder is integrated into, installed into or installed near and connected to electronic and/or optical elements of the subscriber access network. Some examples (FIGS. 4 and 5) of these elements are Optical Transmitters, Optical Receivers, Optical Nodes, Optical Amplifiers, RF amplifiers, Power Supplies, RF transmitters, RF Receivers and other elements connected to the access network media.

The equipment, software (FIG. 1) and protocol that comprise this system include: Network Management software running on a computer, the messages originated by the software, the LAN that connects the computer to a CMTS, the CMTS, access network media consisting of coaxial cable, optical cable, optical and electrical devices (elements) connected to the cables, the use of one of many downstream and upstream communications channels transmitted over the access network media, a fraction of the data carrying capacity of that downstream and upstream channel, the transmission of downstream and upstream messages over the channel and targeted to one or many devices attached to the network, the transponder module, the applications module.

There are various transponder configurations and embodiments for the implementation within device to be managed. Two are illustrated by FIGS. 2 and 3.

### DESCRIPTION OF DRAWINGS

FIG. 1—The System

FIG. 2—Transponder w/general purpose analog and digital managed device interface

FIG. 3—Transponder w/ANSI/SCTE 25-3 2001 (formerly HMS 022) managed device Interface

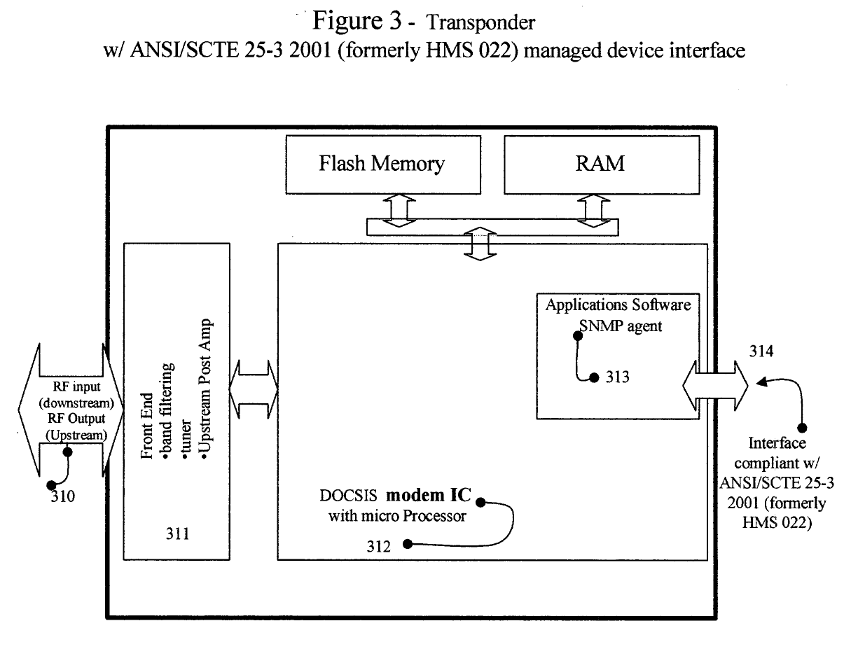

FIG. 4—Optical Node with Transponder Module Installed

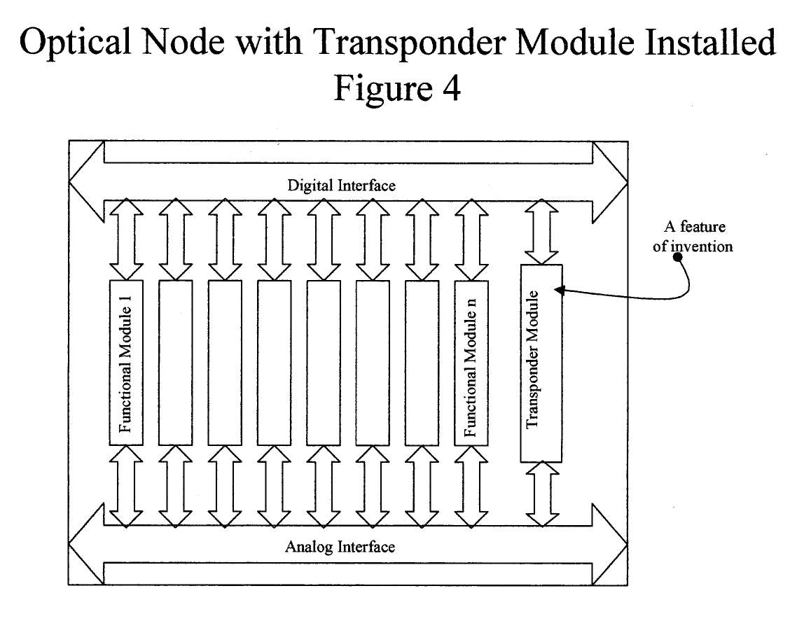

FIG. 5—Power Supply with Transponder Installed

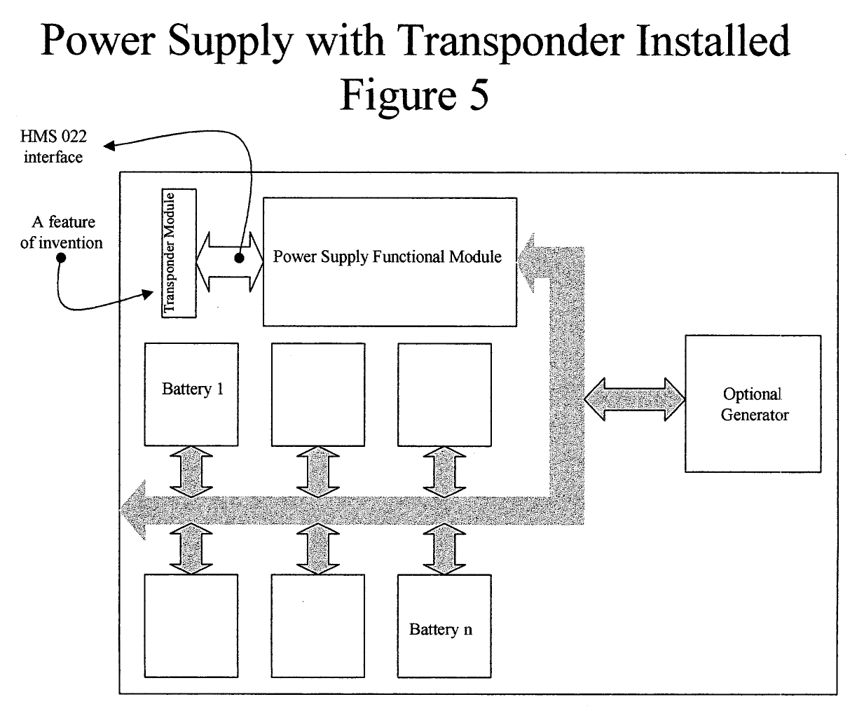

### DETAILED DESCRIPTION OF PREFERED EMBODYMENT

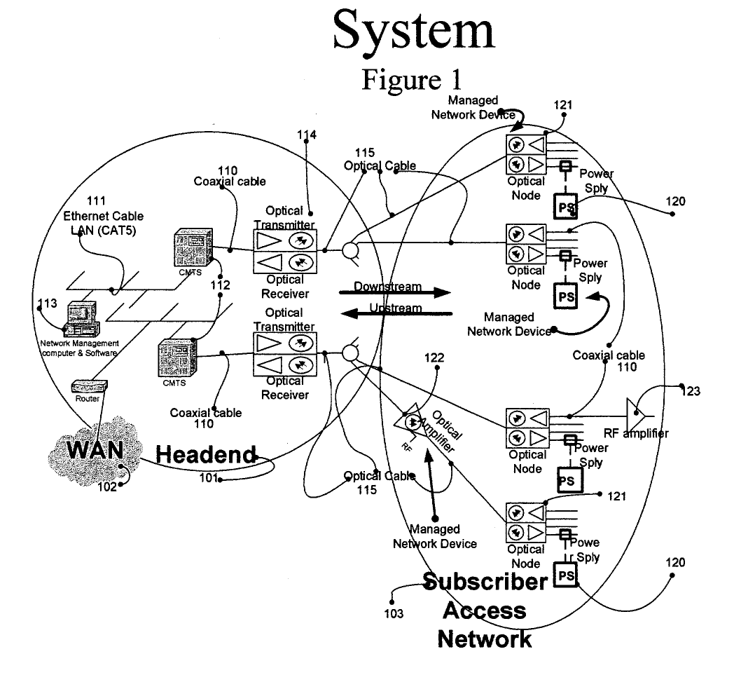

The system FIG. 1 comprises of a headend 101 and a subscriber access network 103. Contained within the headend 101 is a network management computer system(s) 113 that is programmed with network management software. The software implements standard SNMP protocol. The computer system 113 is connected to a CMTS router 112 via a local area network 111. In other configurations the network management computer 113 can be connected from a remote location via a wide area network (WAN) 102. Ethernet is shown in the FIG. 1 as the local area technology, however, any local area network technology can be applied. The CMTS 112 is connected to the optical transmitters and receivers 114 for transmission of network management communications downstream and upstream through coaxial cable network 110. The optical transmitters and receivers 114 connect the headend equipment 101 to the subscriber access network 103 through 115 optical fiber cable.

Network management communications originate and terminate at the computer system 113 and travel via the described system to and from managed devices 120, 121, 122, 123 in the subscriber access network 103. Examples of managed devices in the Subscriber access network are Optical Node 121, Power Supply 120, Optical Amplifiers 122, RF Amplifiers 123 or anything that uses a transponder to communicate to a network management system.

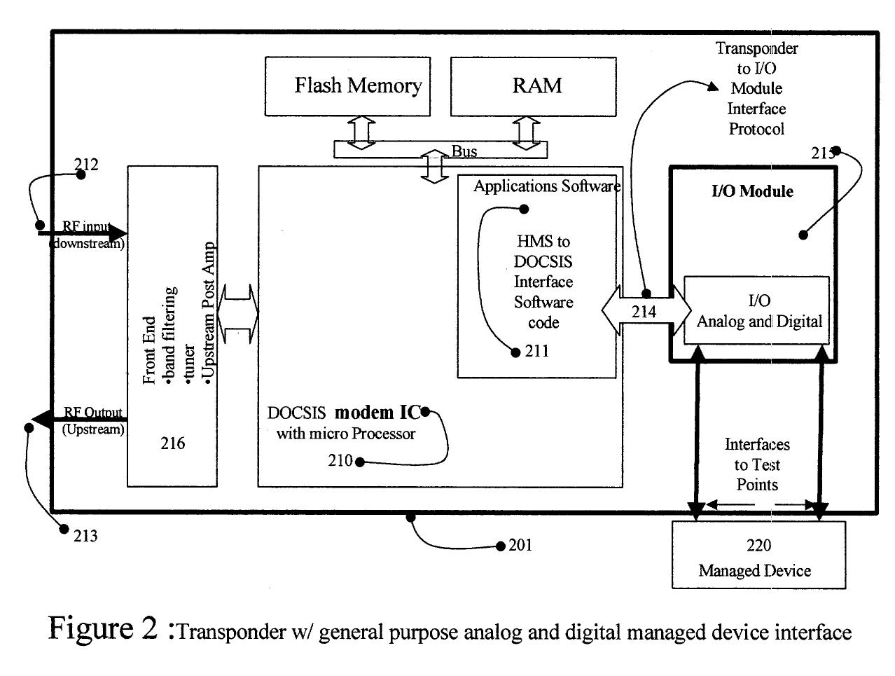

Each managed device is equipped with a transponder 201, FIG. 2 which is connected to a plurality of test points within the managed device 220 and the transponder measures and monitors performance and alarm status indicators and communicates that information via the subscriber access network 103 and the headend equipment 101 to the network management computer system 113.

Refer to FIG. 2, the transponder 201 is comprised of an RF input 212, and RF output 213. The RF input and RF output can be optionally configured on a single coaxial connector, or one coaxial connector for input and one coaxial connector for output, or on a multiple terminal connector that has the RF input and RF output on subset of its terminals, depending on the implementation requirement of the monitored device in which it is contained or interfaced. The transponder contains a front end 216 that performs the functions of a frequency tuner, frequency converter, and band pass filter to receive, select and process the downstream communication. The front end 216 can also contain a post amplifier for the upstream-transmitted communications channel. The front end 216 conforms to the physical and electrical specification contained in the DOCSIS suite of specifications. The front end 216 connects to an integrated circuit that is designed to implement the Media Access Control functions of the DOCSIS specification. The integrated circuit also provides microprocessor facilities where HMS applications software 211 and I/O Module Interface protocol 214 applications software program code is implemented. I/O module 215 control messages are routed via a physical interface provided on the integrated circuit to an input/output module (I/O module) 215. The control messages are interpreted by the I/O module 215. In reaction to the control messages, the I/O module measures test point values, and responds back to the HMS applications software 211 on the integrated circuit. The HMS applications software 211 processes the information received from the I/O module 215 and forwards it to the Media Access and Physical layer function provide by the DOCSIS integrated circuit 210 thereby communicating via the subscriber access network 101 and the headend 101 to the management system computer 113.

The I/O module 215 and managed device 220 are interfaces via a connector.

What is claimed:

1) A system that applies the DOCSIS suite of specifications and SCTE HMS suite of specifications and provides an interaction and cooperation between the two standards.

2) A system (FIG. 1) that uses cable modem equipment, in particular CMTS devices, and extends the application thereof to implement network management services for network elements (devices) that do not have facilities for communication using DOCSIS protocols.

3) A transponder that contains an integrated circuit that use the DOCSIS suite of specifications and a software program that implements the SCTE HMS suite of specifications to implement element management services.

4) A transponder having an RF input, an RF output, a Transponder to I/O Module Interface Protocol, an integrated circuit that use the DOCSIS suite of specifications, a software program that implements the SCTE HMS suite of specifications, SNMP agent software, I/O Module having a plurality analog and digital inputs and outputs.

5) A transponder module having an RF input, an RF output, an integrated circuit that use the DOCSIS suite of specifications, a software program that implements the SCTE HMS suite of specifications, SNMP agent software, and a digital input and output connection that is compliant with the standard ANSI/SCTE 25-3 2001 (formerly HMS 022).

6) An I/O Module that implements a Transponder to I/O Interface, connects to a transponder module containing an integrated circuit implementing the DOCSIS suite of specifications and containing a software program that implements the SCTE HMS suite of specifications, has a plurality of input and output ports that connect to a managed device for the measurement of electrical values and/or the control of functions in a managed device.

7) The use of a part of the capacity contained in one downstream and one upstream DOCSIS channel for the purpose of communicating network management messages to and from managed devices that contain network management transponders.

8) The use of a part of the capacity contained in one downstream and one upstream DOCSIS channel for the purpose of communicating network management messages to and from element management transponders or modems that are installed in or integrated into a Optical Node, Optical Amplifier or RF Amplifier. and Power Supplies.

9) The use of a CMTS as the bridge (FIG. 1) between the Headend LAN data network that carries management messages and the HFC Subscriber Access Network to communicate upstream and downstream messages to and from the Management System computer and the transponder modules connected to the devices being managed.

10) The implementation of network management for an HFC Subscriber Access Networks and Managed devices without a specialized and dedicated headend controller. A headend controller is sometimes referred to as a head end modem or HMTS.
